(19) United States
(12) Patent Application Publication
(10) Pub. No.: US 2018/0086189 A1
(43) Pub. Date: Mar. 29, 2018

(54) ROOF SIDE WEATHER STRIP FOR AUTOMOBILE

(71) Applicant: TOYODA GOSEI CO., LTD., Kiyosu-shi (JP)

(72) Inventors: Kazutaka YAMADA, Kiyosu-shi (JP); Kiyotaka TAMAOKI, Kiyosu-shi (JP); Nobuo HAYAMA, Kariya-shi (JP)

(21) Appl. No.: 15/686,345

(22) Filed: Aug. 25, 2017

(30) Foreign Application Priority Data
Sep. 28, 2016 (JP) 2016-189222

(51) Int. Cl. B60J 10/77; B60J 10/16

(52) U.S. Cl. CPC B60J 10/77; B60J 10/235; B60J 10/16

(57) ABSTRACT

A roof side weather strip for an automobile includes: a mounting base portion; and a seal portion, wherein: the seal portion is separately provided with a first seal portion and a second seal portion; the mounting base portion at least has a bottom wall and a vehicle interior side wall, the vehicle interior side wall is formed of a solid material, and a portion of the roof side weather strip other than the vehicle interior side wall is formed of a sponge material; the bottom wall has a bottom wall vehicle exterior portion and a bottom wall connecting portion; and the vehicle interior side wall has a vehicle interior side wall root portion, a vehicle interior side wall distal end portion, and a vehicle interior side wall main body portion, and a vehicle interior side wall engaging projection is formed in the vehicle interior side wall root portion.

### CROSS-REFERENCE TO RELATED APPLICATION(S)

This application is based upon and claims the benefit of priority from Japanese Patent Application No. 2016-189222, filed on Sep. 28, 2016, the entire contents of which are incorporated herein by reference.

### BACKGROUND

### 1. Field of the Invention

The present invention relates to a roof side weather strip for an automobile for providing a seal between an upper portion of a door opening edge in a vehicle body of an automobile and a door glass of a door.

### 2. Description of the Related Art

The vehicle body of an automobile of a sashless door type is now adopted in which a door sash is not provided and only a door glass 5 is freely raised and lowered in an upper portion of a belt line portion of a door 1. By this configuration, when the automobile is viewed from the side, only the door glass 5 becomes visible from the outside in the upper portion of the belt line portion of the door 1.

In this case, sealing between the upper portion of the door opening edge in the vehicle body and the door glass 5 is attained by the door glass 5 being brought into abutment with a roof side weather strip 110 mounted on an upper portion of a vehicle body opening peripheral edge 6 as illustrated in FIG. 2. A retainer 4, which is formed integrally with a roof molding 2 functioning as a molding portion, is mounted on the vehicle body opening peripheral edge 6.

As illustrated in FIG. 3, the roof side weather strip 110 is made up of a mounting base portion 111 mounted on the retainer 4 of the vehicle body opening peripheral edge 6, and a seal portion 150 brought into abutment with an upper end of the door glass 5 to provide a seal. The mounting base portion 111 is made up of a vehicle exterior side wall 120, a vehicle interior side wall 130, and a bottom wall 140.

The seal portion 150 is formed by a seal wall 151 which is brought into abutment with the upper end of the door glass 5 and a hollow portion 152, and when the door glass 5 is brought into abutment therewith, the seal wall 151 is deflected towards the inside of the hollow portion 152 and encompasses the upper end of the door glass 5 to provide a seal thereat (for example, refer to JP-A-2003-54329). In addition, a trim 170 is mounted on a flange of the vehicle body opening peripheral edge 6 so that a cover lip 159 which is provided to extend from the roof side weather strip 110 is brought into abutment with the trim to cover a gap.

However, in this case, unlike the case of a sashed door, the door glass 5 is not held along an outer peripheral edge of an upper portion and side portions thereof by the door sash and the glass run, and hence, the door glass 5 becomes easy not only to be deviated at an upper end position thereof but also to be deflected towards the vehicle exterior side. Thus, there has occurred a case where the position at which the door glass 5 is brought into abutment with the seal portion 150 when the door is closed changes and thus the seal portion 150 is abnormally deformed to deteriorate the sealability in some cases.

Thus, as illustrated in FIG. 4, there exists a configuration in which a hollow seal portion is divided into two portions to provide a seal in two locations of an upper end of the door glass 5 and a vehicle interior side surface of an upper end portion thereof, so that seals are provided with respect to the respective abutment directions of the door glass 5 by the divided seal portions, respectively (for example, refer to JP-A-2009-6823).

In FIG. 4, a roof side weather strip 210 is made up of a mounting base portion 211 mounted on a vehicle body opening peripheral edge 6, and a first seal portion 250 and a second seal portion 260 which are two seal portions formed integrally with the mounting base portion 211 and separately from each other.

The first seal portion 250 is formed on a vehicle exterior side of the mounting base portion 211 and is provided to extend from an upper end and a root of a vehicle exterior side wall 220 respectively to form a hollow shape. The first seal portion is brought into abutment with a distal end of the door glass 5 to provide a seal thereat.

The mounting base portion 211 is made up of the vehicle exterior side wall 220, a vehicle interior side wall 230, and a bottom wall 240. The mounting base portion 211 is formed of a solid material from the viewpoint of securing easy insertion property at the time of assembly and holding strength to the retainer 4 after assembly. The first seal portion 250 and the second seal portion 260 are formed of a sponge material.

The roof side weather strip 210 is mounted by engaging an engaging portion 232 provided at a distal end of a cover portion 231 which is formed on a vehicle interior outer surface of the vehicle interior side wall 230 with the retainer 4 mounted on the roof molding 2. In this case, since the engaging portion 232 is engaged with the outer side of the retainer 4, a configuration in which the vicinity of the retainer 4 is spacious is required. However, a configuration capable of obtaining stable insertability even with a configuration in which the vicinity of the retainer 4 is not spacious has been desirably required.

Therefore, in the automobile of a sashless door type, there has been a demand for a roof side weather strip which is easily assembled to a retainer at a vehicle body opening peripheral edge.

### SUMMARY

According to a first aspect of the present invention, there is provided a roof side weather strip for an automobile, mounted on a retainer of a vehicle body opening peripheral edge of a vehicle body of an automobile of a sashless door type to provide a seal between the vehicle body opening peripheral edge and a peripheral portion of a door glass of a door, the roof side weather strip including: a mounting base portion mounted on the retainer of the vehicle body opening peripheral edge; and a seal portion formed integrally with the mounting base portion to provide a seal between the vehicle body opening peripheral edge and the door glass, wherein: the seal portion is separately provided with a first seal portion providing a seal by being brought into abutment with an upper end of the door glass on an inner peripheral side of the mounting base portion, and a second seal portion providing a seal by being brought into abutment with a vehicle interior side surface of a distal end portion of the door glass; the mounting base portion at least has a bottom wall and a vehicle interior side wall formed integrally with a vehicle interior side end of the mounting base portion, the vehicle interior side wall is formed of a solid material, and a portion of the roof side weather strip other than the vehicle interior side wall is formed of a sponge material; the bottom wall has a bottom wall vehicle exterior portion brought into abutment with the retainer and a bottom wall connecting portion formed to be continuous to the bottom wall vehicle exterior portion; and the vehicle interior side wall has a vehicle interior side wall root portion formed to be continuous to the bottom wall connecting portion, a vehicle interior side wall distal end portion, and a vehicle interior side wall main body portion connecting the vehicle interior side wall root portion and the vehicle interior side wall distal end portion, and a vehicle interior side wall engaging projection protruding in a vehicle interior direction and engaged with a portion to be engaged in the retainer is formed in the vehicle interior side wall root portion.

In the first aspect, the roof side weather strip has the mounting base portion mounted on the retainer of the vehicle body opening peripheral edge, and the seal portion formed integrally with the mounting base portion to provide a seal between the vehicle body opening peripheral edge and the door glass. Therefore, when the mounting base portion is mounted on the retainer of the vehicle body opening peripheral edge, the position of the seal portion is fixed and abutment with the door glass can be reliably attained. Thus, it is possible to provide a seal thereat.

The seal portion is separately provided with the first seal portion providing a seal by being brought into abutment with the upper end of the door glass on the inner peripheral side of the mounting base portion, and the second seal portion providing a seal by being brought into abutment with the vehicle interior side surface of the distal end portion of the door glass. Therefore, double sealing can be attained at the upper end of the door glass and the vehicle interior side surface of the upper end portion thereof, and thus sealability can be improved. Even when the door glass is brought into abutment with the seal portion in a horizontal direction while the door is closed, and even when the door glass is brought into abutment with the seal portion from the lower side while the door glass is raised or lowered, the deformation of the first seal portion and the second seal portion is not mutually affected and the respective seal portions can provide independent seals. Thus, it is possible to secure sealability.

The mounting base portion at least has the bottom wall and the vehicle interior side wall formed integrally with the vehicle interior side end of the mounting base portion, the vehicle interior side wall is formed of a solid material, and the portion of the roof side weather strip other than the vehicle interior side wall is formed of a sponge material. Therefore, the vehicle interior side wall engaging projection can be reliably engaged with the portion to be engaged in the retainer by preventing the deformation of the vehicle interior side wall and inserting the vehicle interior side wall into the depth of the retainer. Thus, good assemblability can be obtained.

Since the bottom wall has the bottom wall vehicle exterior portion brought into abutment with the retainer and the bottom wall connecting portion formed to be continuous to the bottom wall vehicle exterior portion, the bottom wall vehicle exterior portion is brought into abutment with the retainer to support the bottom wall, and the bottom wall connecting portion is connected to the vehicle interior side wall so that the roof side weather strip can be held by the retainer at both the bottom wall and the vehicle interior side wall.

The vehicle interior side wall has the vehicle interior side wall root portion formed to be continuous to the bottom wall connecting portion, the vehicle interior side wall distal end portion, and the vehicle interior side wall main body portion connecting the vehicle interior side wall root portion and the vehicle interior side wall distal end portion. Therefore, the vehicle interior side wall root portion is continuous to the bottom wall and is held by the retainer together with the vehicle interior side wall main body portion as the mounting base portion. The vehicle interior side wall distal end portion can hold the second seal portion to provide a seal.

When the vehicle interior side wall root portion is inserted, due to the bottom wall being formed of a sponge material, the deformation stress of the bottom wall is small and the vehicle interior side wall engaging projection easily rides over the inner wall of the portion to be engaged in the retainer. Thus, it is possible to improve assemblability. Therefore, the roof side weather strip can be engaged into the inside of the retainer and even in the case where the vicinity of the retainer is less spacious, good assemblability can be obtained.

According to a second aspect of the present invention, in the vehicle interior side wall root portion, a portion continuous to the bottom wall connecting portion may have a vehicle interior side wall protrusion protruding in a vehicle exterior direction.

In the second aspect, since the portion of the vehicle interior side wall root portion continuous to the bottom wall connecting portion has the vehicle interior side wall protrusion protruding in the vehicle exterior direction, when the vehicle interior side wall is engaged with the portion to be engaged in the retainer, the reaction force generated when the bottom wall vehicle exterior portion of the bottom wall is brought into abutment with the retainer presses the vehicle interior side wall protrusion. Thus, the vehicle interior side wall engaging projection can reliably ride over the step portion of the portion to be engaged in the retainer, and the feeling when the vehicle interior side wall engaging projection rides over the step portion of the portion to be engaged in the retainer can be transmitted to an inserter.

According to a third aspect of the present invention, the vehicle interior side wall engaging projection may be formed in a lip shape, a root portion of the vehicle interior side wall engaging projection may be continuous to the vehicle interior side wall root portion, a vehicle interior side wall engaging projection recess may be formed in a portion on the vehicle interior side wall main body portion side, and when the vehicle interior side wall engaging projection is engaged with the portion to be engaged in the retainer, a space may be formed between the portion to be engaged in the retainer and the vehicle interior side wall engaging projection.

In the third aspect, since the vehicle interior side wall engaging projection is formed in a lip shape, the vehicle interior side wall engaging projection can be reliably brought into abutment with the retainer vehicle interior step portion to provide a seal.

The root portion of the vehicle interior side wall engaging projection is continuous to the vehicle interior side wall root portion, the vehicle interior side wall engaging projection recess is formed in the portion on the vehicle interior side wall main body portion side, and when the vehicle interior side wall engaging projection is engaged with the portion to be engaged in the retainer, a space is formed between the portion to be engaged in the retainer and the vehicle interior side wall engaging projection. Therefore, it is possible to reliably prevent the vehicle interior side wall engaging lip from floating by resting the vicinity of the continuous portion of the vehicle interior side wall engaging lip and the vehicle interior side wall main body portion on the retainer vehicle interior step portion. After the vehicle interior side wall is mounted on the retainer, the distal end of the vehicle interior side wall engaging projection is brought into abutment with the portion to be engaged in the retainer in a line-contact state. Thus, it is possible to improve sealability.

According to a fourth aspect of the present invention, the bottom wall connecting portion may have a shape bent to be convex in an inner peripheral direction of the roof side weather strip, and a distance between the bottom wall connecting portion and a bottom wall of the retainer may continuously increase in the vehicle interior direction.

In the fourth aspect, the bottom wall connecting portion has a shape bent to be convex in an inner peripheral direction of the roof side weather strip and a distance between the bottom wall connecting portion and a bottom wall of the retainer continuously increases in the vehicle interior direction. Therefore, a portion that is bent due to stress concentration is not formed on the bottom wall connecting portion and when the mounting base portion is mounted on the retainer, the bottom wall connecting portion can be reliably mounted without abnormal deformation.

According to a fifth aspect of the present invention, the vehicle interior side wall distal end portion may be formed thicker than the vehicle interior side wall main body portion.

In the fifth aspect, since the vehicle interior side wall distal end portion is formed thicker than the vehicle interior side wall main body portion, when the vehicle interior side wall is engaged with the portion to be engaged in the retainer, the vehicle interior side wall distal end portion is easily pressed and thus insertion force can be reliably transmitted to the vehicle interior side wall main body portion and the vehicle interior side wall distal end portion.

According to a sixth aspect of the present invention, the vehicle interior side wall main body portion and a portion of the retainer opposite to the vehicle interior side wall main body portion may be mounted to be in line-contact with each other at a distal end and a root of the portion to be engaged in the retainer.

In the sixth aspect, the vehicle interior side wall main body portion and the portion of the retainer opposite to the vehicle interior side wall main body portion are mounted to be in line-contact with the vehicle interior side wall main body portion at the distal end and the root of the portion to be engaged in the retainer. Therefore, the distal end of the portion to be engaged in the retainer and the step portion are brought into abutment with the bent vehicle interior side wall of the distal end of the vehicle interior side wall main body portion and the root portion of the vehicle interior side wall engaging projection in the line-contact state, respectively. Thus, it is possible to improve sealability.

According to a seventh aspect of the present invention, the first seal portion may be formed integrally with the bottom wall vehicle exterior portion or a vehicle exterior side wall of the mounting base portion and the bottom wall connecting portion, and the second seal portion may be formed integrally with the vehicle interior side wall and the bottom wall connecting portion.

In the seventh aspect, the first seal portion is formed integrally with the bottom wall vehicle exterior portion or the vehicle exterior side wall of the mounting base portion and the bottom wall connecting portion, and the second seal portion is formed integrally with the vehicle interior side wall and the bottom wall connecting portion. Therefore, the first seal portion can reliably provide a seal by being brought into abutment with the distal end of the door glass and the second seal portion can reliably provide a seal by being brought into abutment with the vehicle interior surface of the door glass.

According to an eighth aspect of the present invention, the retainer may be mounted on a roof molding fixed to the vehicle body opening peripheral edge.

In the eighth aspect, since the retainer is mounted on the roof molding fixed to the vehicle body opening peripheral edge, the vehicle body opening peripheral edge can be decorated and the door glass can be prevented from being sucked out to the vehicle exterior side by holding the upper end of the door glass with the roof molding.

According to a ninth aspect of the present invention, the first seal portion and the second seal portion may be formed in a hollow shape.

In the ninth aspect, since the first seal portion and the second seal portion are formed in a hollow shape, when the upper end of the door glass is brought into abutment with the first seal portion and the second seal portion is brought into abutment with the vehicle interior surface of the door glass, deflection can be easily made, and thus sealing can be reliably attained.

According to a tenth aspect of the present invention, the vehicle interior side wall distal end portion may be provided with a cover lip provided to extend in the vehicle interior direction.

In the tenth aspect, since the vehicle interior side wall distal end portion is provided with a cover lip provided to extend in the vehicle interior direction, even when the door glass is brought into abutment with the second seal portion, only the distal end of the second seal portion on the vehicle exterior side is deformed and a gap between the roof side weather strip and the garnish can be reliably covered without deformation of the cover lip.

Since the vehicle interior side wall of the mounting base portion is formed of a solid material, the engaging portion of the vehicle interior side wall can be reliably engaged with the portion to be engaged in the retainer by preventing the vehicle interior side wall from being deformed and inserting the vehicle interior side wall into the depth of the retainer. Therefore, good assemblability can be obtained.

When vehicle interior side wall root portion is inserted into the retainer, the deformation stress of the bottom wall is small due to the bottom wall being formed of a sponge material, the engaging portion of the vehicle interior side wall easily rides over the inner wall of the portion to be engaged in the retainer, and thus, assemblability can be improved. Therefore, the vehicle interior side wall can be easily engaged with the inside of the retainer and thus even in the case where the vicinity of the retainer is less spacious, good assemblability can be obtained.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a partial cross-sectional view of an upper portion of a vehicle body opening peripheral edge in an embodiment of the present invention taken along a line A-A in FIG. 2;

FIG. 2 is a side view of an automobile;

FIG. 3 is a cross-sectional view of a roof side weather strip in the related art; and

FIG. 4 is a cross-sectional view of another roof side weather strip in the related art.

### DETAILED DESCRIPTION OF THE INVENTION

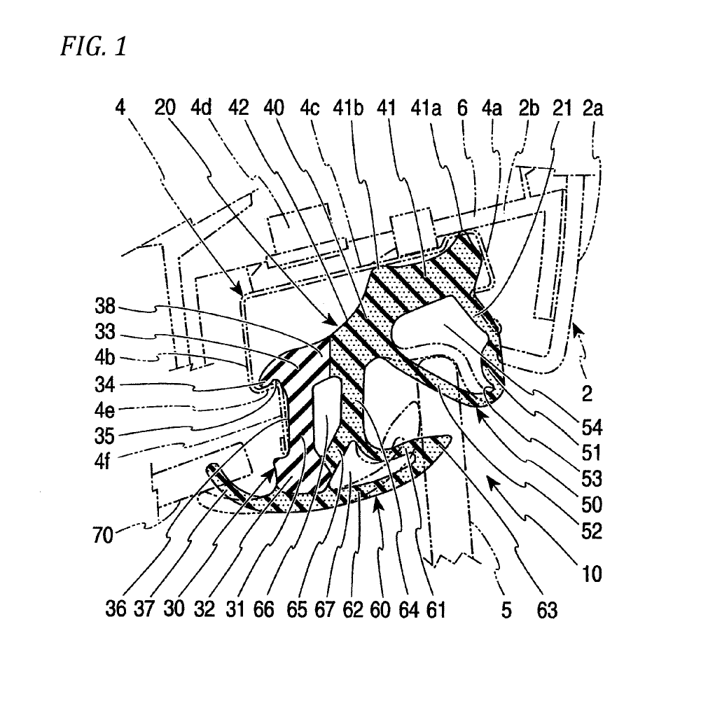

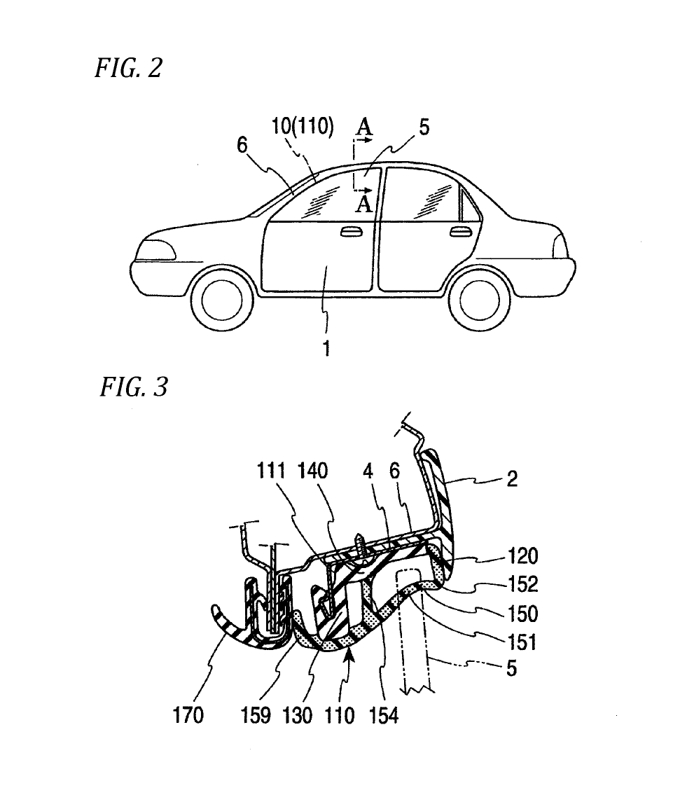

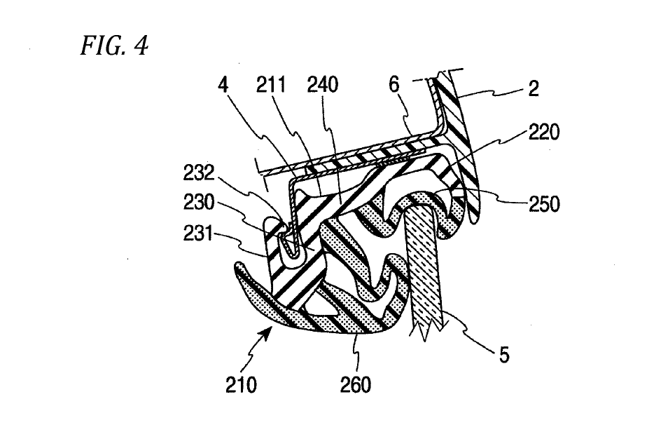

An embodiment of the present invention will be described based on FIGS. 1 and 2.

FIG. 1 illustrates the embodiment of the present invention. FIG. 2 is a side view of an automobile. As illustrated in FIG. 2, a roof side weather strip 10 of the present invention is used for an automobile of a sashless door type, and door sashes are not provided in upper portions, which lie upper than belt line portions of both the doors, of both front and rear doors 1, which are side doors of the automobile, and door glasses 5 are provided over almost the whole of the respective doors, so that the door glasses 5 can be raised and lowered vertically from and into the doors 1.

FIG. 1 is a cross-sectional view, taken along the line A-A in FIG. 2, illustrating a state in which a roof molding 2 and the roof side weather strip 10 are mounted.

In a roof side of a vehicle body, an outer panel for the roof side continuous from a roof and bent toward the vehicle interior side is formed in the vicinity of a vehicle body opening peripheral edge 6. In an inlet portion of the vehicle body opening peripheral edge 6 of the outer panel, a flat portion which houses upper ends of door glasses of the front and rear doors is formed. The roof molding 2 is mounted on a lower surface of the flat portion.

The roof molding 2 is formed by a molding outer panel 2a which extends in a direction from the front side to the rear side on a vehicle exterior surface of the vehicle body opening peripheral edge 6 and a molding mounting leg portion 2b which extends from a rear surface of the molding outer panel 2a in an approximately L-shaped cross section and is in close contact with the flat portion of the vehicle body opening peripheral edge 6 to mount the roof molding 2. The molding outer panel 2a and the molding mounting leg portion 2b are fixed with a double sided adhesive tape or the like. The molding mounting leg portion 2b and the vehicle body opening peripheral edge 6 are fixed together with a retainer 4, which will be described later, using a retainer mounting screw 4d, a clip, a double sided adhesive tape, or the like.

The retainer 4 having an approximately U-shaped cross section is mounted on the molding mounting leg portion 2b. In the retainer 4, a vehicle exterior side of the retainer 4 forms a retainer vehicle exterior side wall 4a, a vehicle interior side forms a retainer vehicle interior side wall 4b, and a retainer bottom wall 4c which connects the retainer vehicle exterior side wall 4a and the retainer vehicle interior side wall 4b is formed.

As described above, the retainer bottom wall 4c is mounted on the vehicle body opening peripheral edge 6 together with the molding mounting leg portion 2b of the roof molding 2.

The retainer vehicle exterior side wall 4a has a step portion formed at the center portion and a connecting portion of a bottom wall vehicle exterior side portion 41 of the bottom wall 40 of the roof side weather strip 10 which will be described later and a vehicle exterior side wall 21 which will be described later is engaged with the step portion.

In the retainer vehicle interior side wall 4b, a retainer vehicle interior step portion 4e is formed at the center portion, and a vehicle interior side wall engaging lip 34 of a vehicle interior side wall 30 of the roof side weather strip 10, which will be described later, is engaged with the retainer vehicle interior step portion 4e. A retainer vehicle interior engaging portion 4f is formed at a distal end side of the retainer vehicle interior step portion 4e of the retainer vehicle interior side wall 4b.

In the embodiment, as a vehicle interior side wall engaging projection, a lip-shaped vehicle interior side wall engaging lip 34 is used. However, in addition to the lip shape, a projection type can be also used.

The roof side weather strip 10 is mounted on the roof molding 2 and the retainer 4. The roof side weather strip 10 is made up of a mounting base portion 20 and a seal portion, and the mounting base portion 20 is formed by the vehicle exterior side wall 21, the vehicle interior side wall 30, and the bottom wall 40. The vehicle exterior side wall 21 is omitted and a first seal portion 50, which will be described later, can be directly formed from the bottom wall 40.

The vehicle exterior side wall 21 is brought into abutment with the retainer vehicle exterior side wall 4a, the root thereof is provided to extend from the end portion of a bottom wall vehicle exterior portion 41 which will be described later, and the distal end thereof is continuous to the first seal portion 50 which will be described later.

In the roof side weather strip 10, the vehicle interior side wall 30 is formed of a solid material and the portion other than the vehicle interior side wall 30 is formed of a sponge material.

The bottom wall 40 has the bottom wall vehicle exterior portion 41 which is formed on the vehicle exterior side and is brought into abutment with the retainer bottom wall 4c, and a bottom wall connecting portion 42 which is formed to be continuous to the bottom wall vehicle exterior portion 41.

The step portion at the center portion of the retainer vehicle exterior side wall 4a is engaged with the continuous portion of the bottom wall vehicle exterior portion 41 and the vehicle exterior side wall 21 to hold the bottom wall vehicle exterior portion 41 and the vehicle exterior side wall 21.

In the bottom wall vehicle exterior portion 41, a bottom wall vehicle exterior portion first projection 41a is formed in a distal end portion of a surface opposite to the retainer bottom wall 4c on the vehicle exterior side and a bottom wall vehicle exterior portion second projection 41b is formed in a portion on the bottom wall connecting portion 42 side. The bottom wall vehicle exterior portion first projection 41a and the bottom wall vehicle exterior portion second projection 41b are brought into abutment with the retainer bottom wall 4c to provide a seal thereat.

The bottom wall connecting portion 42 connects the bottom wall vehicle exterior portion 41 and the vehicle interior side wall 30. Therefore, the bottom wall vehicle exterior portion 41 is brought into abutment with the retainer 4 to support the bottom wall 40, and the bottom wall connecting portion 42 is connected to the vehicle interior side wall 30 so that the roof side weather strip 10 can be held by the retainer 4 at both the bottom wall 40 and the vehicle interior side wall 30.

The bottom wall connecting portion 42 has a shape bent to be convex in an inner peripheral direction of the roof side weather strip 10 (on the lower side in FIG. 1) and is formed in a smooth arc shape such that a distance between the bottom wall connecting portion and the retainer bottom wall 4c continuously increases in the vehicle interior direction. Accordingly, since the bottom wall connecting portion 42 does not have a bending point, a portion which is bent due to stress concentration is not formed and abnormal deformation in which the bottom wall connecting portion 42 is wrinkled or bent when the mounting base portion 20 is mounted on the retainer 4 is avoided. Thus, the mounting base portion 20 can be reliably mounted.

The vehicle interior side wall 30 is formed of a solid material and has a vehicle interior side wall root portion 33 which is formed to be continuous to the bottom wall connecting portion 42, a vehicle interior side wall distal end portion 32 which is formed at a distal end of the vehicle interior side wall 30, and a vehicle interior side wall main body portion 31 which connects the vehicle interior side wall root portion 33 and the vehicle interior side wall distal end portion 32. The vehicle interior side wall root portion 33 is formed to be continuous to the bottom wall 40 and held by the retainer 4 as the mounting base portion 20. The vehicle interior side wall distal end portion 32 can hold a second seal portion 60 which will be described later to provide a seal.

In the vehicle interior side wall root portion 33, a vehicle interior side wall engaging lip 34 protruding in the vehicle interior direction (in the left direction in FIG. 1) and engaged with the retainer vehicle interior step portion 4e which is a portion to be engaged in the retainer 4 on the vehicle interior side is formed. Since the vehicle interior side wall engaging lip 34 is engaged with the retainer vehicle interior step portion 4e, the roof side weather strip 10 can be reliably held by the retainer 4 together with the bottom wall vehicle exterior portion 41.

Since the vehicle interior side wall engaging lip 34 is formed to be continuous to the vehicle interior side wall root portion 33, the vehicle interior side wall engaging lip 34 can be inserted into the retainer 4 to be engaged, and compared to the case where the engaging portion of the vehicle interior side wall 30 is formed on the outside of the retainer 4, the space in the vicinity of the retainer 4 can be reduced.

As illustrated in FIG. 1, it is preferable that the root portion of the vehicle interior side wall engaging lip 34 be continuous to the vehicle interior side wall root portion 33, and a vehicle interior side wall engaging lip recess 35 is formed in a portion on the vehicle interior side wall main body portion 31 side. In this case, when the vehicle interior side wall engaging lip 34 is engaged with the retainer vehicle interior step portion 4e, a space is formed between the retainer vehicle interior step portion 4e and the vehicle interior side wall engaging lip 34 by the vehicle interior side wall engaging lip recess 35.

Due to the space formed by the vehicle interior side wall engaging lip recess 35, when the vehicle interior side wall 30 is engaged with the retainer vehicle interior side wall 4b of the retainer 4, it is possible to reliably prevent the vehicle interior side wall engaging lip 34 from floating by resting the vicinity of the continuous portion of the vehicle interior side wall engaging lip 34 and the vehicle interior side wall main body portion 31 on the retainer vehicle interior step portion 4e. After the vehicle interior side wall 30 is mounted on the retainer 4, only the distal end of the vehicle interior side wall engaging lip 34 is brought into abutment with the retainer vehicle interior step portion 4e in a line-contact state and thus sealability can be improved.

In the vehicle interior side wall root portion 33, it is preferable that a portion continuous to the bottom wall connecting portion 42 form a vehicle interior side wall protrusion 38 protruding in the vehicle exterior direction (the right direction in FIG. 1). In this case, by positioning an end portion of the vehicle interior side wall protrusion 38 having high rigidity so as to protrude to the middle of the bottom wall connecting portion 42, when the mounting base portion 20 is mounted on the retainer 4, in a state in which the bottom wall vehicle exterior portion 41 is brought into abutment with the retainer vehicle exterior side wall 4a, the vehicle interior side wall 30 is pushed in a direction of the retainer bottom wall 4c to engage the vehicle interior side wall 30 with the retainer vehicle interior side wall 4b, and thus, when the vehicle interior side wall protrusion 38 and the vehicle interior side wall engaging lip 34 ride over the retainer vehicle interior step portion 4e, the bottom wall connecting portion 42 is compressed.

When the vehicle interior side wall engaging lip 34 rides over and is engaged with the retainer vehicle interior step portion 4e, a feeling of moderation (feeling of impact) can be obtained by the repulsive force of the compression, and thus, the vehicle interior side wall engaging lip 34 can be reliably engaged. This phenomenon becomes remarkable as the protrusion allowance of the vehicle interior side wall protrusion 38 in the vehicle exterior direction increases.

With the configuration in which the vehicle interior side wall protrusion 38 is formed to the vicinity of a second seal root portion 64, the shape at the connecting portion of the bottom wall connecting portion 42 and the second seal root portion 64 is supported and deformation of the second seal root portion 64 and a second seal bridge portion 65 is suppressed. Thus, the effect of suppressing the movement of the door glass 5 to the vehicle interior side can be also obtained in the second seal portion 60.

In the retainer vehicle interior side wall 4b, the retainer vehicle interior step portion 4e is formed at the center portion and a retainer vehicle interior engaging portion 4f is formed on a distal end side of the retainer vehicle interior step portion 4e. The retainer vehicle interior engaging portion 4f is a portion on which the vehicle interior side wall main body portion 31 is mounted.

The shape of the cross section of the retainer vehicle interior engaging portion 4f is a linear shape. On the other hand, the shape of the cross section of a vehicle interior side wall main body outer surface 36 is formed such that a portion close to the vehicle interior side wall engaging lip 34 is bent and a portion close to a vehicle interior side wall distal end portion 32 is also bent. Therefore, when the vehicle interior side wall main body portion is mounted such that the mounting angle of the vehicle interior side wall main body portion 31 with respect to the retainer vehicle interior engaging portion 4f is different, the root portion of the retainer vehicle interior engaging portion 4f can be brought into contact with the bent portion of the vehicle interior side wall main body outer surface 36 close to the vehicle interior side wall engaging lip 34 and the distal end portion of the retainer vehicle interior engaging portion 4f can be brought into contact with the bent portion close to the vehicle interior side wall distal end portion 32. Thus, it is possible to form a gap between the retainer vehicle interior engaging portion 4f and the vehicle interior side wall.

In this case, since the vehicle interior side wall distal end portion 32 of the vehicle interior side wall main body outer surface 36 of the vehicle interior side wall main body portion 31 is bent, the distal end of the retainer vehicle interior engaging portion 4f is brought into abutment with the bent portion in a line-contact state. In the root side of the vehicle interior side wall main body outer surface 36 of the vehicle interior side wall main body portion 31, a portion continuous to the root portion of the vehicle interior side wall engaging lip 34 is bent and thus the root portion of the retainer vehicle interior engaging portion 4f can be brought into abutment with the bent portion on the root side of the vehicle interior side wall main body outer surface 36 of the vehicle interior side wall main body portion 31 in a line-contact state. In this manner, by adopting the configuration in which the surfaces of the vehicle interior side wall 30 and the retainer vehicle interior side wall 4b are not brought into contact with each other, a misalignment phenomenon caused by variations in both parts and variations in assembly can be prevented from occurring and a stable assembly state can be obtained.

The vehicle interior side wall distal end portion 32 is preferably formed thicker than the vehicle interior side wall main body portion 31. In this case, when the vehicle interior side wall 30 is engaged with the retainer vehicle interior engaging portion 4f and the retainer vehicle interior step portion 4e of the retainer 4, the area pressing the vehicle interior side wall distal end portion 32 is increased and the vehicle interior side wall distal end portion 32 is easily pressed. Thus, insertion force can be reliably transmitted to the vehicle interior side wall distal end portion 32 and the vehicle interior side wall main body portion 31. The vehicle interior side wall engaging lip 34 can be engaged with the retainer vehicle interior step portion 4e by causing the vehicle interior side wall engaging lip 34 to slide on the inner surface of the retainer vehicle interior engaging portion 4f.

The seal portion of the roof side weather strip 10 is made up of the first seal portion 50 formed on the vehicle exterior side of the mounting base portion 20 and the second seal portion 60 formed on the vehicle interior side.

The first seal portion 50 is formed of a sponge material and is formed in a hollow shape. The first seal portion is formed by a first seal vehicle exterior holding wall 51 continuous to the distal end of the vehicle exterior side wall 21, and a first seal abutment wall 52 continuous from the bottom wall connecting portion 42 of the bottom wall 40 and has a first hollow seal portion 54. When the door glass 5 is raised and closed, the first seal abutment wall 52 is brought into abutment with the distal end of the door glass 5 to provide a seal thereat.

The first seal vehicle exterior holding wall 51 can be formed directly from the bottom wall vehicle exterior side portion 41.

The first seal vehicle exterior holding wall 51 and a distal end of the first seal abutment wall 52 are formed to be connected to each other, and a first seal recess 53 is formed in the connecting portion.

A distal end of the molding outer panel 2a of the roof molding 2 is brought into abutment with the outer surface of the first seal vehicle exterior holding wall 51. The abutting portion of the first seal vehicle exterior holding wall 51 is formed thick.

The second seal portion 60 is formed of a sponge material and is formed in a hollow shape. The second seal portion is provided to integrally extend from the bottom wall connecting portion 42 and the vehicle interior side wall 30.

The second seal root portion 64 is integrally formed from bottom wall connecting portion 42 and a second seal interior holding wall 61 is provided to extend from a distal end of the second seal root portion 64.

A second seal bridge portion 65 is provided to extend from the connecting portion of the second seal root portion 64 and the second seal interior holding wall 61 so as to be continuous to the vehicle interior side wall distal end portion 32. A portion surrounded by the second seal root portion 64, the second seal bridge portion 65, and the vehicle interior side wall main body portion 31 forms a second seal first hollow portion 66.

A second seal exterior holding wall 62 is provided to extend from the distal end of the vehicle interior side wall distal end portion 32 in the vehicle exterior direction. A distal end of the second seal exterior holding wall 62 and a distal end of the second seal interior holding wall 61 are connected to each other to form a second seal distal end portion 63 directed in a direction of the door glass 5. The second seal distal end portion 63 can provide a seal by being brought into abutment with a vehicle interior surface of the door glass 5.

A portion surrounded by the second seal exterior holding wall 62, the second seal interior holding wall 61, and the second seal bridge portion 65 forms a second seal second hollow portion 67.

A vehicle interior side wall cover lip 37 is provided to extend from the distal end of the vehicle interior side wall distal end portion 32 in the vehicle interior direction. The vehicle interior side wall cover lip 37 is formed to be continuous to the second seal exterior holding wall 62, covers the distal end of the vehicle interior side wall distal end portion 32, and is formed of a sponge material. The distal end of the vehicle interior side wall cover lip 37 is brought into abutment with a garnish 70 to cover a gap between the roof side weather strip 10 and the garnish 70.

Next, based on FIG. 1, a state in which the door glass 5 is brought into abutment with the roof side weather strip 10 will be described.

When the door glass 5 is raised, as indicated by a two-dot broken line in FIG. 1, the upper end of the door glass 5 is brought into abutment with the first seal abutment wall 52 of the first seal portion 50, and the first seal recess 53 is deflected. The first seal abutment wall 52 is deflected towards the inside of the first hollow portion 54 so as to encompass the upper end of the door glass 5.

Since the first seal portion 50 is formed in a hollow shape and is formed of a sponge material, the first seal portion can be flexibly deformed. Therefore, it is possible to secure a seal between the upper end of the door glass 5 and the first seal portion 50. Since the first seal vehicle exterior holding wall 51 is held by the molding outer panel 2a, the upper end of the door glass 5 can be held not to be displaced towards the vehicle exterior side.

When the door glass 5 is raised, as indicated by the two-dot broken line in FIG. 1, the second seal distal end portion 63 of the second seal portion 60 is brought into abutment with the vehicle interior side surface of the upper end portion of the door glass 5. As the door glass 5 is raised, the second seal distal end portion 63 is slid on the vehicle interior side surface of the door glass 5 while being bent upward and provides a seal between the vehicle interior side surface of the door glass 5 and the second seal portion 60.

Therefore, double sealing can be attained with the upper end of the door glass 5 and the vehicle interior side surface of the upper end portion thereof and thus sealability can be improved. Since the first seal portion 50 and the second seal portion 60 are formed separately, when the door is closed and when the door glass 5 is raised or lowered, the deformation of the first seal portion 50 and the second seal portion 60 is not mutually affected and the respective seal portions can provide independent seals, thereby making it possible to securing the sealability.

The second seal portion 60 is formed to be bent in the continuous portion of the second seal root portion 64 and the second seal interior holding wall 61 such that the cross section is further bent and deformed into an L-shape when the second seal portion is brought into abutment with the vehicle interior side surface of the door glass 5 while the door is closed or the like. Therefore, when the door glass 5 is brought into abutment with the second seal portion, the second seal portion 60 is flexibly bent and deformed, and even when the position of the door glass 5 is shifted, the second seal portion 60 can be reliably brought into abutment with the door glass 5 to provide a seal.

Since the second seal distal end portion 63 of the second seal portion 60 is formed not in a lip shape but in a hollow shape, when the door glass 5 is raised or lowered, compared to a lip shape, the rigidity is large, the second seal distal end portion is not caught, and abnormal deformation does not occur. When the second seal portion is brought into abutment with the door glass 5, the second seal portion is bent at a predetermined bent portion as described above. Thus, the amount of change of the entire second seal portion 60 is small and sealability is not deteriorated.

In the roof side weather strip 10, a synthetic rubber, a thermoplastic elastomer, and a soft synthetic resin are used for both the solid material and the sponge material, and as the synthetic rubber, the thermoplastic elastomer, and the soft synthetic resin, for example, an EPDM rubber, an olefin-based elastomer, and a soft vinyl chloride are used, respectively.

The synthetic rubber is transferred to a vulcanization tank to be heated by hot air or high frequency waves for vulcanization. The thermoplastic elastomer and the soft synthetic resin are cooled to be solidified. Thereafter, these materials are cut by a predetermined length, thereby manufacturing extruded components.

What is claimed is:

1. A roof side weather strip for an automobile, mounted on a retainer of a vehicle body opening peripheral edge of a vehicle body of an automobile of a sashless door type to provide a seal between the vehicle body opening peripheral edge and a peripheral portion of a door glass of a door, the roof side weather strip comprising:
a mounting base portion mounted on the retainer of the vehicle body opening peripheral edge; and
a seal portion formed integrally with the mounting base portion to provide a seal between the vehicle body opening peripheral edge and the door glass, wherein:
the seal portion is separately provided with a first seal portion providing a seal by being brought into abutment with an upper end of the door glass on an inner peripheral side of the mounting base portion, and a second seal portion providing a seal by being brought into abutment with a vehicle interior side surface of a distal end portion of the door glass;
the mounting base portion at least has a bottom wall and a vehicle interior side wall formed integrally with a vehicle interior side end of the mounting base portion, the vehicle interior side wall is formed of a solid material, and a portion of the roof side weather strip other than the vehicle interior side wall is formed of a sponge material;
the bottom wall has a bottom wall vehicle exterior portion brought into abutment with the retainer and a bottom wall connecting portion formed to be continuous to the bottom wall vehicle exterior portion; and
the vehicle interior side wall has a vehicle interior side wall root portion formed to be continuous to the bottom wall connecting portion, a vehicle interior side wall distal end portion, and a vehicle interior side wall main body portion connecting the vehicle interior side wall root portion and the vehicle interior side wall distal end portion, and a vehicle interior side wall engaging projection protruding in a vehicle interior direction and engaged with a portion to be engaged in the retainer is formed in the vehicle interior side wall root portion.

2. The roof side weather strip for an automobile according to claim 1, wherein
in the vehicle interior side wall root portion, a portion continuous to the bottom wall connecting portion has a vehicle interior side wall protrusion protruding in a vehicle exterior direction.

3. The roof side weather strip for an automobile according to claim 1, wherein
the vehicle interior side wall engaging projection is formed in a lip shape, a root portion of the vehicle interior side wall engaging projection is continuous to the vehicle interior side wall root portion, a vehicle interior side wall engaging projection recess is formed in a portion on the vehicle interior side wall main body portion side, and when the vehicle interior side wall engaging projection is engaged with the portion to be engaged in the retainer, a space is formed between the portion to be engaged in the retainer and the vehicle interior side wall engaging projection.

4. The roof side weather strip for an automobile according to claim 1, wherein:
the bottom wall connecting portion has a shape bent to be convex in an inner peripheral direction of the roof side weather strip; and
a distance between the bottom wall connecting portion and a bottom wall of the retainer continuously increases in the vehicle interior direction.

5. The roof side weather strip for an automobile according to claim 1, wherein
the vehicle interior side wall distal end portion is formed thicker than the vehicle interior side wall main body portion.

6. The roof side weather strip for an automobile according to claim 1, wherein
the vehicle interior side wall main body portion and a portion of the retainer opposite to the vehicle interior side wall main body portion are mounted to be in line-contact with each other at a distal end and a root of the portion to be engaged in the retainer.

7. The roof side weather strip for an automobile according to claim 1, wherein
the first seal portion is formed integrally with the bottom wall vehicle exterior portion or a vehicle exterior side wall of the mounting base portion and the bottom wall connecting portion, and the second seal portion is formed integrally with the vehicle interior side wall and the bottom wall connecting portion.

8. The roof side weather strip for an automobile according to claim 1, wherein
the retainer is mounted on a roof molding fixed to the vehicle body opening peripheral edge.

9. The roof side weather strip for an automobile according to claim 1, wherein
the first seal portion and the second seal portion are formed in a hollow shape.

10. The roof side weather strip for an automobile according to claim 1, wherein
the vehicle interior side wall distal end portion is provided with a cover lip provided to extend in the vehicle interior direction.
